(19) United States
(12) Patent Application Publication
(10) Pub. No.: US 2023/0291319 A1
(43) Pub. Date: Sep. 14, 2023

(54) SYSTEM AND METHOD FOR PROVIDING A COMPENSATION FACTOR FOR A DC/DC CONVERTER

(71) Applicant: Lear Corporation, Southfield, MI (US)

(72) Inventors: Rafael JIMENEZ PINO, Valls (ES); Pablo GAONA ROSANES, Valls (ES); Hector SARNAGO ANDIA, Ólvega (ES); Oscar LUCIA GIL, Zaragoza (ES)

(21) Appl. No.: 17/690,913

(22) Filed: Mar. 9, 2022

(51) Int. Cl. H02M 3/335; B60L 53/20

(52) U.S. Cl. CPC H02M 3/33573; H02M 3/33592; B60L 53/20; B60L 2210/10

(57) ABSTRACT

In at least one embodiment, a power conversion device for a vehicle is provided. At least one controller is configured to selectively switch a first plurality of switches and a second plurality of switches to convert a first input signal into a first output signal. The at least one controller is further configured to receive a high voltage signal on a primary side and to receive a low voltage signal on the secondary side. The at least controller is further configured to generate a compensation factor based at least on the high voltage signal and the low voltage signal. The at least one controller is further configured to provide a first activation signal to control the switching of the first plurality of switches and the second plurality of switches based at least on the compensation factor.

### TECHNICAL FIELD

Aspects disclosed herein may generally relate to a system and method for providing a compensation factor for a DC/DC converter. In one example the DC/DC converter may be used for charging a vehicle. These aspects and others will be discussed in more detail below.

### BACKGROUND

US Patent Publication No. 2014/0361742 to CHUNG et al. provides an electric vehicle charger including a DC/DC converter and control circuits. The DC/DC converter includes an inverter module; a transformer module connected to the inverter module; and a converter module connected to the transformer module. The control circuits include a multi-loop feedback control system connected to the converter module; and gate driving circuits connected to the multi-loop feedback control system and the inverter module. The inverter module includes an IGBT bridge. The transformer module includes a transformer. The converter module includes a diode rectifier bridge.

### SUMMARY

In at least one embodiment, a power conversion device for a vehicle is provided. The power conversion device includes a transformer and at least one controller. The transformer includes a primary side and a secondary side. The at least one controller is configured to selectively switch a first plurality of switches on the primary side and a second plurality of switches on the secondary side to convert a first input signal into a first output signal. The at least one controller is further configured to receive a high voltage signal on the primary side and to receive a low voltage signal on the secondary side. The at least one controller is further configured to generate a compensation factor based at least on the high voltage signal and the low voltage signal. The at least one controller is further configured to provide a first activation signal to control the switching of the first plurality of switches and the second plurality of switches based at least on the compensation factor.

In at least one embodiment, a method for operating a power conversion device for a vehicle is provided. The method includes selectively switching a first plurality of switches on a primary side of a transformer and a second plurality of switches on a secondary side of the transformer to convert a first input signal into a first output signal and receiving a high voltage signal on the primary side in response to converting the first input signal into the first output signal. The method further includes receiving a low voltage signal on the secondary side in response to converting the first input signal into the first output signal. The method further includes generating a compensation factor based at least on the high voltage signal and the low voltage signal and providing a first activation signal to control the switching of the first plurality of switches and the second plurality of switches based at least on the compensation factor.

In at least one embodiment, a computer-program product embodied in a non-transitory computer readable medium that is programmed to operate a power conversion device for a vehicle is provided. The computer-program product comprising instructions to selectively switch a first plurality of switches on a primary side of a transformer and a second plurality of switches on a secondary side of the transformer to convert a first input signal into a first output signal and to receive a high voltage signal on the primary side in response to converting the first input signal into the first output signal. The method further includes receiving a low voltage signal on the secondary side in response to converting the first input signal into the first output signal. The computer-program product comprising instructions to generate a compensation factor based at least on the high voltage signal and the low voltage signal to provide a first activation signal to control the switching of the first plurality of switches and the second plurality of switches based at least on the compensation factor.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts one example of a resonant LLC topology;

FIG. 2 depicts one example of a synchronous buck-boost DC/DC converter;

FIG. 3 depicts one example of a classic LLC DC/DC converter;

FIG. 4 depicts one example of a DC/DC converter (DAB) with a single primary winding and multiples secondaries windings in accordance with one embodiment;

FIG. 5 depicts one example of the DC/DC converter (DAB) with a single primary winding and a single secondary winding in accordance with one embodiment;

FIG. 6 generally depicts various signals in the DC/DC converter (DAB) configuration as illustrated in FIG. 5;

FIG. 7 generally depicts various signals in the classical LLC topology as illustrated in FIG. 3;

FIG. 8 generally depicts the DC/DC converter (DAB) configuration along with a power rating for portions of the DC/DC converter in accordance with one embodiment;

FIG. 9 generally depicts a first set of operation signals in the DC/DC converter (DAB) of FIG. 5 in a buck mode in accordance with one embodiment;

FIG. 10 generally depicts a second set of operation signals in the DC/DC converter (DAB) of FIG. 5 in a boost mode in accordance with one embodiment;

FIG. 11 generally depicts a controller associated with the DC/DC converter in accordance with one embodiment;

FIG. 12 generally depicts a more detailed implementation of a microcontroller within the controller in accordance with one embodiment;

FIG. 13 depicts a voltage at a primary side of the DC/DC converter (DAB) in accordance with one embodiment;

FIG. 14 depicts a voltage at a secondary side of the DC/DC converter (DAB) in accordance with one embodiment;

FIG. 15 depicts a first portion of a control circuit for selectively controlling one or more switches on a primary side of the DC/DC converter in accordance with one embodiment;

FIG. 16 depicts corresponding first and second activation signals (T₁ and T₂) for selectively controlling the one or more switches on the primary side of the DC/DC converter while the DC/DC converter is in the buck mode in accordance with one embodiment;

FIG. 17 depicts a second portion of the control circuit for selectively controlling one or more switches on the secondary side of the DC/DC converter in accordance with one embodiment;

FIG. 18 depicts corresponding first and second signals (T₁ and T₂) for selectively controlling the one or more switches on the secondary side of the DC/DC converter while the DC/DC converter is in the buck mode in accordance with one embodiment;

FIG. 19 depicts corresponding first and second activation signals (T₁ and T₂) for selectively controlling the one or more switches on the primary side of the DC/DC converter while the DC/DC converter is in the boost mode in accordance with one embodiment; and

FIG. 20 depicts corresponding first and second activation signals (T₁ and T₂) for selectively controlling the one or more switches on the secondary side of the DC/DC converter while the DC/DC converter is in the boost mode in accordance with one another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is recognized that various electrical devices such as servers, controllers, and clients, etc. as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, these electrical devices utilize one or more microprocessors to execute a computer-program that is embodied in a non-transitory computer readable medium that is programmed to perform any number of the functions as disclosed. Further, the various electrical devices as provided herein include a housing and various numbers of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The electrical devices also include hardware-based inputs and outputs for receiving and transmitting data, respectively from and to other hardware-based devices as discussed herein.

A DC/DC converter converts a DC input voltage into a DC output voltage. More particularly, a boost DC/DC converter converts a DC input voltage with a DC input current into a higher DC output voltage with a lower DC output current. Conversely, a buck DC/DC converter converts a DC input voltage with a DC input current into a lower DC output voltage with a higher DC output current.

A DC/DC converter includes a set of input power switches, a transformer, and a set of output power switches. The input power switches are controlled to invert the DC input voltage into an AC input voltage. The transformer transforms the AC input voltage into an AC output voltage having a different voltage level. The output power switches are controlled to rectify the AC output voltage into the DC output voltage.

As examples, DC/DC converters, as provided herein, may be configured to provide the following DC input/output pairings: 400-12; 48-12; 400-48; and 800-12. As such, for instance, a 400-12 V DC/DC converter may be used to convert a 400 V DC input into a 12 V DC output. As such, the 400-12 V DC/DC converter may be used between a 400 V DC network and a 12 V DC network to thereby connect these two voltage networks together. Of course, the DC/DC converters are usable over voltage ranges. For example, the 400-12 V DC/DC converter may be used to convert a DC input voltage falling within a voltage range of 250-470 V DC into a DC output voltage into a 12 V DC output voltage.

A vehicle may have a high-voltage (HV) network and a low-voltage (LV) network. In this case, a DC/DC converter may be used to connect the HV and LV networks together. Consequently, a high DC input voltage of the HV network may be converted by the DC/DC converter into a low DC output voltage for use by loads connected to the LV network. Conversely, assuming the DC/DC converter is bidirectional, a low DC input voltage of the LV network may be converted by the DC/DC converter into a high DC output voltage for use by loads connected to the HV network.

Nowadays, electric energy conversion may be a well-known technology. Most of the times, energy conversion or regulation may be needed to supply an electric load from an AC (alternate current) or DC (discrete current) source. In the automotive market, historically the electric system has been based in a 12 Vdc battery but, as electronics efficiency has improved, reducing loses and power use, conversion to lower voltages, like 5 Vdc or even 3.3 Vdc may require small energy converters.

But the appearance of the electric or hybrid vehicle, with electric energy applied in the powertrain, may have necessitated the integration of a higher-voltage battery (400V) to store much higher energies. With two voltage networks in the electric architecture of these vehicles, now there is a desire to transfer energy from one network to the other.

In the recent years, such a desire has become regularized with a series of DC voltages (12V, 48V, 400V and 800V) and a power transfer energy ranging from around 500 W to around 5 kW. As this power conversion technology comes from the industrial market, several topologies (electric conversion systems) are available, each one with properties to make it more suitable for a specific conversion scenario.

But in the automotive market, DC-DC converters may be equally required by all original equipment manufacturers (OEMs). Therefore, a common solution to approach all conversion scenarios may be needed. Of course, this combines with the robustness, size and weight optimization, and the minimized product and development costs that are required to all products in the automotive market.

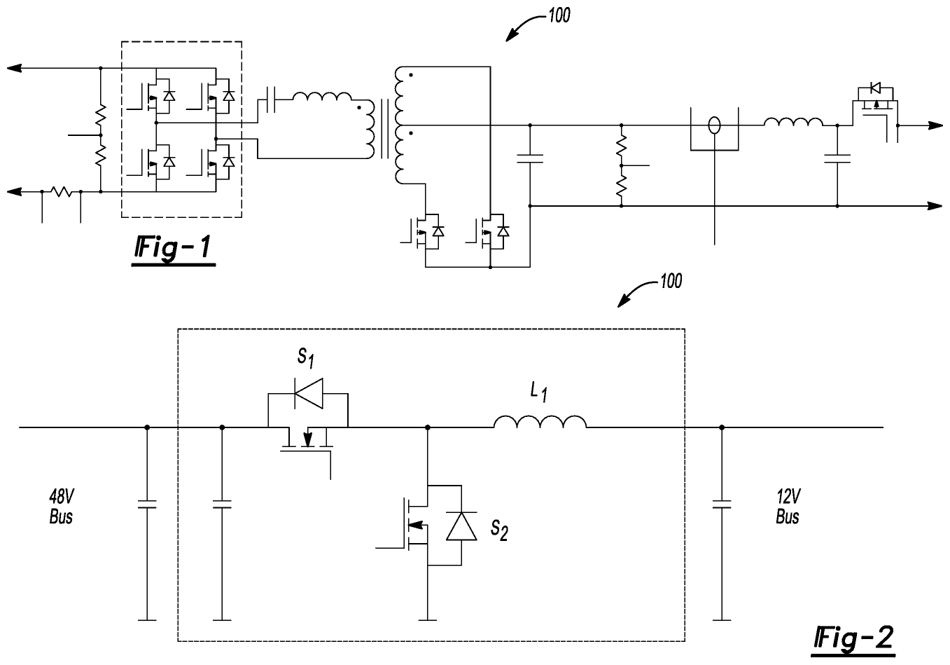

FIG. 1 depicts one example of a resonant (inductor-capacitor) LLC topology 100 that may be used as a DC/DC converter. Specifically, the resonant LLC topology 100 may perform high voltage (HV) to low voltage (LV) DC/DC conversion. In general, components that form the resonant LLC topology 100 may require new components along with new development to support differing converter voltage requirements. For example, the topology 100 may undergo specific adaptation for each customer application.

FIG. 2 depicts one example of a synchronous buck-boost DC/DC converter 110. The converter 110 may be used for medium voltage (MV)-LV DC/DC converter for 3 kW. Similar to the LLC topology 100, components that form the converter 110 may require new components along with new development to support differing converter voltage requirements. Additionally, the converter 110 may undergo specific adaptation for each customer application.

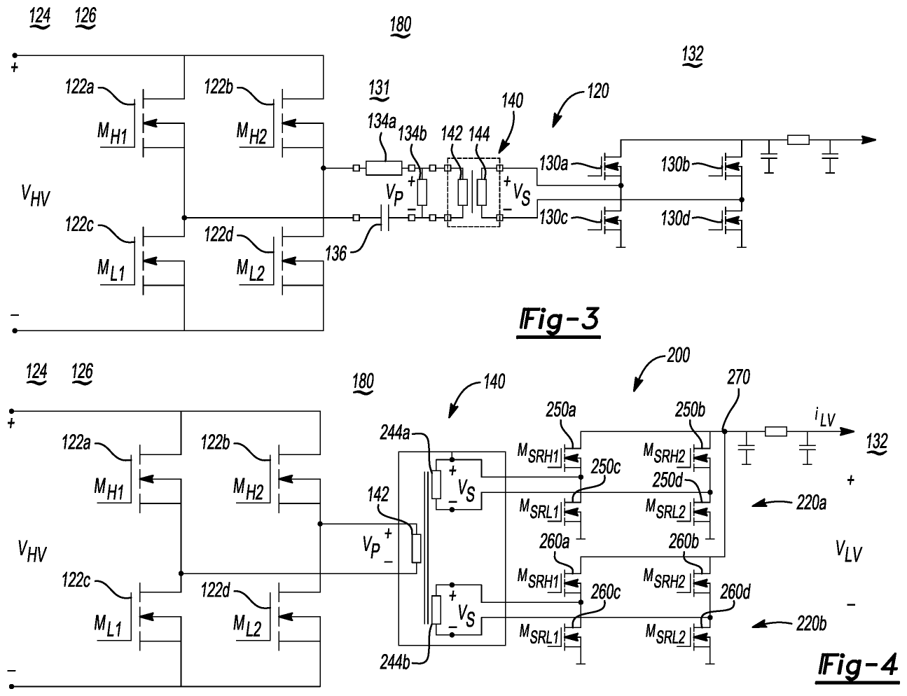

FIG. 3 depicts one example of a classic LLC DC/DC converter 120. The converter 120 generally includes a first plurality of switches 122a-122d (e.g., metal-oxide-semiconductor field-effect transistor (MOSFET) or other suitable variants thereof) positioned on a HV side 124 of a vehicle 126. The converter 120 may also include a second plurality of switches 130a-130d (e.g., metal-oxide-semiconductor field-effect transistor (MOSFET) or other suitable variants thereof) positioned on a LV side 132 of the vehicle 126. A first inductor 134a, a second inductor 134b and capacitor 136 form a resonant network 131 that is operably coupled to an output of the first plurality of switches 122a-122d. A transformer 140 having a primary side (e.g., primary winding) 142 and a secondary side (e.g., secondary winding) 144 is also shown. The converter 120 is generally configured to convert a HV on the HV side 124 into a LV output. Additionally, the converter 120 may convert a LV on the LV side 132 into a HV output. In this regard, the converter 120 is recognized as a bi-directional converter. In general, the first inductor 134a and the second inductor 134b are coupled in series with one another and are also in parallel with the capacitor 136 and the transformer 140. These components form a primary path for energy flow for the converter 120 and may be bulky and expensive.

FIG. 4 depicts one example of a DC/DC converter 200 (or power conversion device) as a dual active bridge (DAB) topology in accordance with one embodiment. The converter 200 may also be a bi-directional converter and generally includes a single primary winding 142 that is operably coupled with a plurality of secondary windings 244a and 244b. On the LV side 132 (or secondary side 144), the DC/DC converter 200 includes first and second half bridge circuits 220a and 220b. In general, multiple half bridges are provided to increase the current output capabilities of the DC/DC converter 200. The first half bridge circuit 220a includes the secondary winding 244a and a first secondary plurality of switches 250a-250d (e.g., (MOSFETs) or other suitable variants thereof). The second half bridge circuit 220b includes the secondary winding 244b and a second secondary plurality of switches 260a-260d (e.g., (MOSFETs) or other suitable variants thereof). The first plurality of switches 122a-122d on the primary side (or HV side 124) generally forms another bridge. A controller 180 is operably coupled to the first plurality of switches 122a-122d and to the first secondary plurality of switches 250a-250d to selectively switch the same.

The first and second half bridge circuits 220a and 220b may be controlled in parallel in the DAB topology. As a result, the activated switches of the first plurality of switches 122a-122d and the second plurality of switches 250a-250d collaborate to define a voltage scenario for inductances of the transformer 140 to linearly increase or decrease the flowing currents accordingly.

That differs, for example, in LLC, where the first bridge provides energy to the LLC system at the primary winding to cause oscillations. Then the transformer of the LLC system transfers the oscillation to the secondary. The secondary bridge converts the energy into DC signals. In one example, with an LLC topology, stages thereof are controlled in series. With the DC/DC converter 200, each stage (e.g., the first half bridge 220a and the second half bridge 220b) is controlled in parallel. In light of this condition, the bridge formed by the switches 122a-122d and the first and second bridge circuits 220a, 220b form a dual active bridge (DAB) topology.

In general, the first half bridge circuit 220a is in parallel with the second half bridge circuit 220b. The first and second half bridge circuits 220a, 220b form a full bridge circuit. Likewise, the secondary windings 244a and 244b are in parallel with one another. The first secondary plurality of switches 250a-250d form an H-bridge structure and the second secondary plurality of switches 260a-260d also form an H-bridge structure. A node 270 is formed on outputs of the first and second half bridge circuits 220a, 220b to provide a current I_{LV}. The outputs from the first and second half bridge circuits 220a, 220b at the node 270 are parallel with one another. Additionally, all ground as depicted in the first and second half bridge circuits 220a, 220b are parallel to one another. The DC/DC converter 200 as illustrated may be implemented into a single printed circuit board (PCB). It is recognized that a controller (not shown) may be provided to control the manner in which the first plurality of switches 122a-122d, the first secondary plurality of switches 250a-250d, and the second secondary plurality of switches 260a-260b are activated and deactivated to convert DC energy bi-directionally. As shown, the DC/DC converter 200 does not utilize any bulky inductors which reduces overall cost and provides for the scalability aspect.

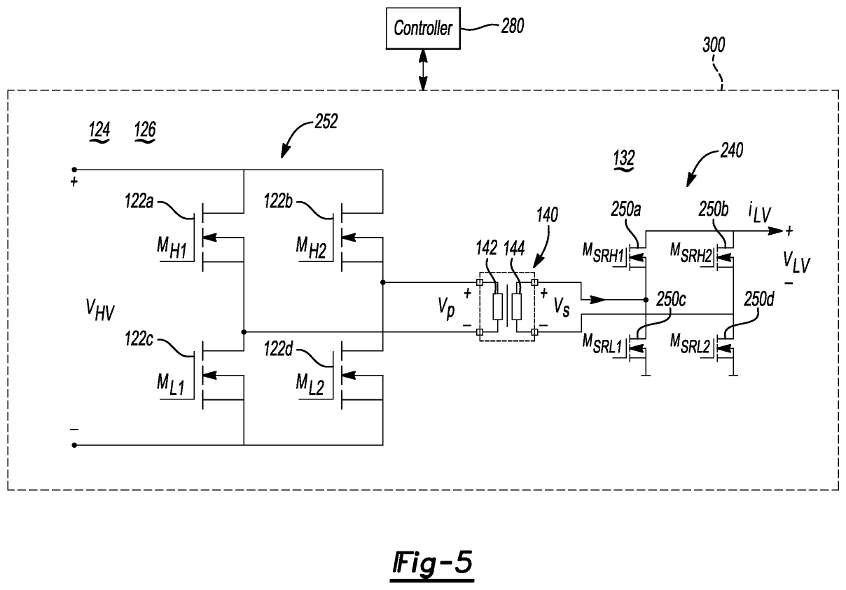

FIG. 5 depicts one example of the DC/DC converter 300 in accordance with one embodiment. The DC/DC converter 300 is generally similar to the DC/DC converter 200 of FIG. 4. However, the DC/DC converter 300 provides a single bridge circuit 240 on the secondary side 144 of the LV side 132. The first plurality of switches 122a-122d form another bridge 252. In this case, the DC/DC converter 300 provides a DAB circuit. The DC/DC converter 300 may provide less current on the LV side 132 than that of the DC/DC converter 300. It is recognized that additional half bridge circuits similar to that illustrated in FIG. 4 may be added to increase the current providing capability for the DC/DC converter 300. In reference to the various DAB topologies as set forth herein, the bridge 252 provides rectification (i.e., rectifies alternating current (or oscillating signal) generated in response to the cycling of the first plurality of switches 122a-122d). The bridge 252 provides an input to the transformer 140 and the transformer 140 provides an output to the single bridge circuit 240 to control bi-directional energy conversion and transfer between the DC networks on the HV side 124 and the LV side 132.

When transferring from the HV side 124 to the LV side 132, a high voltage and low current energy may be supplied to the bridge 252 to generate an oscillation, voltage, and current level conversion which is provided as an output of the single bridge circuit 252 as a low voltage and high current energy. Both bridges 249, 252 may take part in stimulating coupled inductances of the transformer 140 to provide the DC/DC conversion. In a similar way, energy may be transferred from the LV side 132 to the HV side 124 (e.g., from the LV network to the HV network). A controller 280 is operably coupled to the first plurality of switches 122a-122d and to the first secondary plurality of switches 250a-250d to selectively switch the same. The controller 280 may employ digital processing of measured voltages and currents at different stages about the DC/DC converter 300. The controller 280 may compare measured currents to target input values and output values as established by real time needs of the system for the vehicle 126. In general, it is the difference between target values and instant measurements that establish the energy transfer flow and direction.

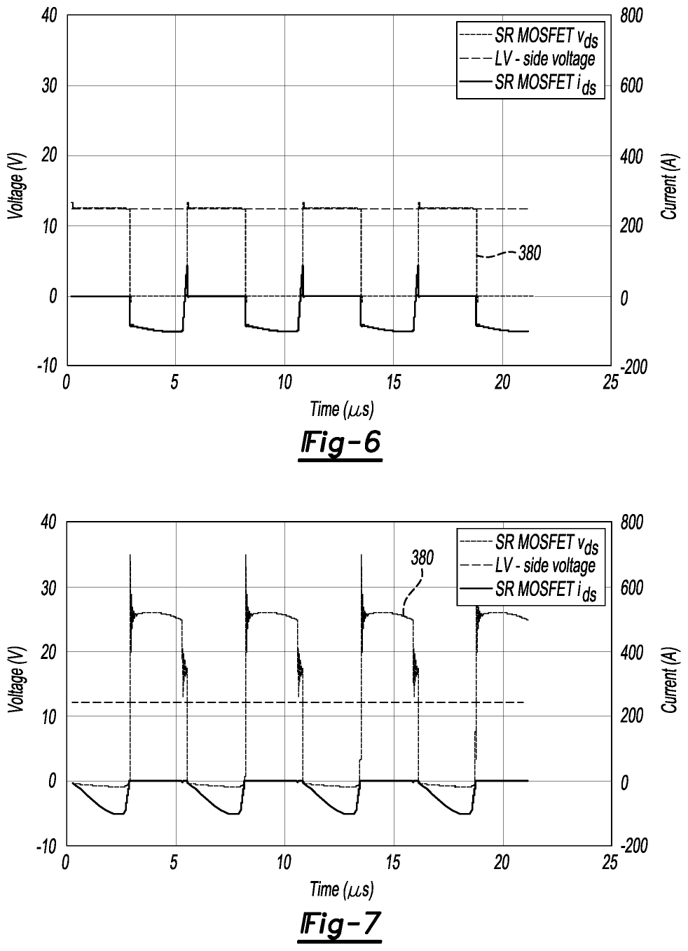

A comparison between the DC/DC converter 300 of FIG. 5 and the DC/DC converter 120 of FIG. 3 may be noticed with the plots of FIGS. 6 and 7. FIG. 6 generally depicts various signals associated the DC/DC converter 300 as illustrated in FIG. 5. FIG. 7 generally depicts various signals in the classical LLC topology as illustrated in DC/DC converter 120 of FIG. 3. As shown in FIG. 6, voltage signal 380 is nearly half of that shown of the voltage signal 380 illustrated in FIG. 7. The voltage signal 380 corresponds to the voltage at the secondary side 144 of the transformer 140. This condition indicates that the DC/DC converter 300 requires lower cost components. For example, the hardware components are less stressed due to the switching waveforms as the switching waveforms are smoother in comparison to that illustrated in FIG. 7. In particular, the voltage signal in FIG. 7 ranges from 0 to approximately 26V (i.e., not counting ringing peaks), while the voltage signal in FIG. 6 ranges from 0 to approximately 12V. This condition may result in less than half of the power being involved. It may also be seen that the switching stability is improved with the DC/DC converter 300 (see FIG. 6) in comparison to the DC/DC converter 120 (see FIG. 7) as FIG. 6 illustrates less spurious ringing with respect to the switches of the DC/DC converter 300. Thus, the DC/DC converter 300 may provide for a stable solution while providing better dynamic response.

The DC/DC converter 300 is generally configured to adapt to different system requirements. In this sense, the same topology of the DC/DC converter 300 may be used for different input and output voltages thereby providing the option of simply selecting components according to the external voltages demands. For example, with a 400V input, the components at the bridge 250 may be selected to withstand 650V, but with an 800V input, these components may move to the 1200V range.

The DC/DC converter 300 may be developed to withstand a limited range of handled powers (e.g., from 500 W to 1 kW) thereby providing a solution in the low range of the automotive needs. Then, if another product is needed with a mild increase of power (e.g., up to 2 kW), the LV side 132 may be required to handle higher current values, may be doubled so that the components at each branch handle half the current and stay at cost-efficient values (e.g., see DC/DC converter 200). Then, the transformer 140 may have as many separate secondary inductances as low-voltage stages. Finally, if the OEM request is for a high power in the market range (e.g., up to 5 kW or even 10 kW), several of the rails may be parallelized sharing a common control system and a common input and output filtering.

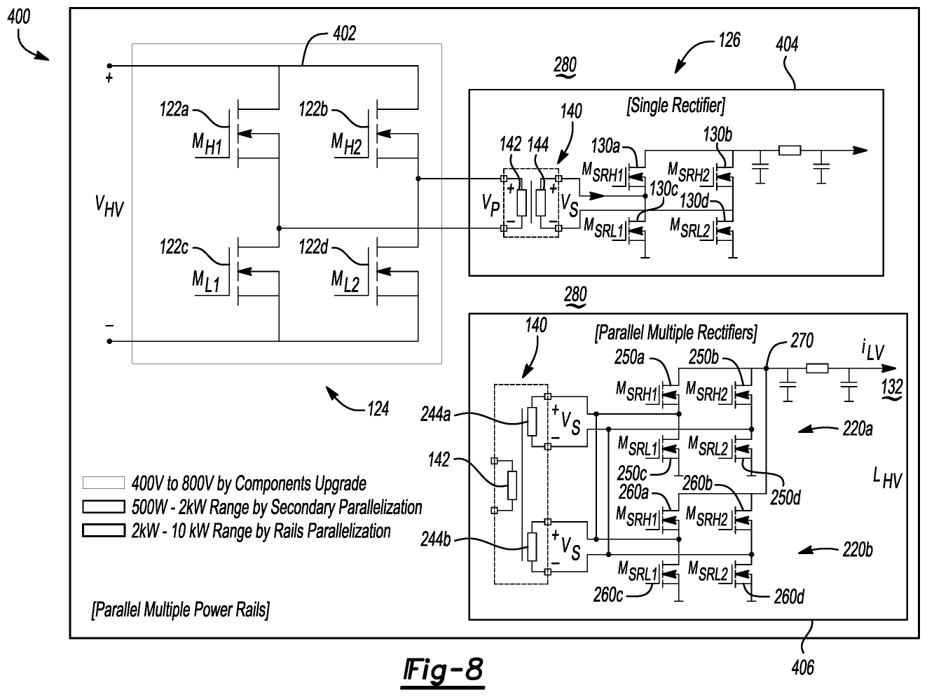

FIG. 8 generally depicts a DC/DC converter 400 for portions of the DC/DC converter as discussed above in connection with FIGS. 4 and 5 in accordance with one embodiment. Specifically, the DC/DC converter 400 includes a primary portion 402 including the various switches 122a-122d position on the HV side 124 of the converter 400 (i.e., to the left of the transformer 140). The DC/DC converter 400 also includes secondary portions 404 and 406 positioned to the right of the transformer 140 on the LV side of the converter 400. The secondary portion 404 may be defined as a single rectifier since it rectifies the AC output generated by the primary portion 402. In this case, the secondary portion 404 includes the single secondary winding 144 and the single set of switches 130a-130d as set forth with the DC/DC converter 300 in FIG. 5.

The secondary portion 406 includes the plurality of secondary windings 244a, 244b, along with the switches 250a-250d and 260a-260d as set forth with the DC/DC converter 200 in FIG. 4. The secondary portion 406 may for a parallel configuration of multiple rectifiers. Generally, the components illustrated in the primary portion 402 may be rated to a voltage of anywhere between 400 and 800V by component upgrade. The components illustrated in the second portions 404, 406 may be rated to a power of anywhere between 500 W-2 kW. The power rating for the DC/DC converter 400 may be anywhere between 2 kW-10 kW range by utilizing the parallel configuration of multiple rails. A single rectifier may handle a range of 500 W-2 kW when migrating to a parallelized structure of n, H-bridge circuits where power may be increased in the range of 2 kW up to 10 kW. In cases of power range of 2 kW up to 10 kW, the H-bridge at the primary side 142 and the transformer 140 may be duplicated. For example, there may be one HV H-bridge, a transformer, and two LV H-bridges in parallel, and this entire circuit (e.g., a rail) may be duplicated in parallel (as two-parallel rails).

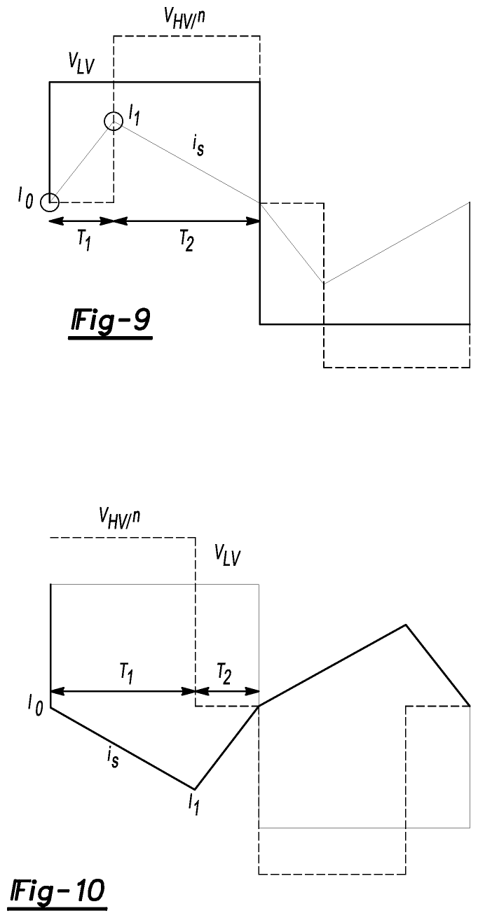

FIG. 9 generally depicts resulting signals while controlling one or more of the switches 122a-122d and 250a-250d of the DC/DC converter 300 of FIG. 5 when the DC/DC converter is in a buck mode in accordance with one embodiment. In terms of a control strategy for the DC/DC converters 200 and 300, such converters 200 and 300 are configured to provide energy transfer, voltages at the input (V_{HV}), the output (V_{LV}), the transformer primary side (vₚ) and secondary side (vₛ) may be measured by voltage sensor(s). In one embodiment, current sensors may obtain a measurement of the current at the secondary (iₛ) (i.e., iₘₑₐₛ) and the current at the LV side 132 (I_{LV}) is needed. In another embodiment, current sensors (or high-speed current measurements) may not be required in order to obtain the current at the secondary (iₛ) (i.e., iₘₑₐₛ). the current at the LV side ((I_{LV}) may be obtained (e.g., measured) at a low speed of, for example, 100 Hz. This will be discussed in more detail below.

The vehicle system generally provides a target (OBJ) for input and output voltages, as well as output current. As design parameters, the transformer leakage inductance (L_{LK}) and the transformer ratio (nₜ) may also be required. To operate the DC/DC converters, the different switches (each of the bridge MOSFETs) 122a-122d, 250a-250d, and/or 260a-260d may be digitally switched to enable a linear current increase or decrease in, for example, four possible phases, or signal period quarters (see T₁ and T₂ in FIG. 9).The rate of increase or decrease at each phase (e.g., the current signal slopes) may be dependent of the system parameters and, thus, constant at each signal period.

At the first period quarter of the current (iₛ) in the secondary side 144 of the transformer 140b (i.e., a first slope) may be calculated as shown below:

$$I ( t ) = \frac{{V}_{LV}}{{L}_{lk}} \cdot t + {I}_{0}$$

where Lₗₖ is a transformer leakage inductance (e.g., a design parameter). And then:

$$@ t = {T}_{1} , I ( {T}_{1} ) = {I}_{1} then$$

$${I}_{1} = \frac{{V}_{LV}}{{L}_{lk}} \cdot {T}_{1} + {I}_{0}$$

At the second period quarter:

$$I ( t ) = \frac{{V}_{LV} - {V}_{HV} / n}{{L}_{lk}} \cdot t + {I}_{1}$$

$$@ t = {T}_{2} , I ( {T}_{2} ) = {I}_{0}$$

and then, at the “zero” crossing:

$${I}_{0} = \frac{{V}_{LV} - {V}_{HV} / n}{{L}_{lk}} \cdot {T}_{2} + {I}_{1}$$

Operating these equations lead to

$${T}_{2} = \frac{{V}_{LV}}{{V}_{LV} - {V}_{HV} / n} \cdot {T}_{1} = α \cdot {T}_{1}$$

Where n is a design parameter (e.g., number of turns of the transformer 140). A compensation factor α may be determined as follows:

α=V_{LV}/(V_{LV}−V_{HV}/n)

The compensation factor α may be used instead of the measured current iₛ that is typically provided by one or more current sensors. This aspect will be discussed in more detail below. In general, the equations noted above illustrate that the current is triangular, the ratio between T₁ and T₂ may only be dependent on the voltages that form compensation factor α. Thus, in this regard, the energy transfer, which is dependent on the working frequency, may be controlled primarily from the voltages V_{LV} and V_{HV}.

In addition, the current on the transformer 140 is following the triangular waveform as shown in FIGS. 9 & 10 for the converter 300. Under the triangular waveform, T1 & T2 can be calculated while approaching linear equations since there is a relationship among I₀ & I₁ with V_{LV} & V_{HV} measurements because of current on the transformer 140 rises/decreases in a linear manner.

To vary the energy transfer by the DC/DC converter 300 (e.g., via the current amplitude), only the duration of the quarters may be adjusted (T₁ and T₂). Thus, according to the energy transfer needs (the voltage and current targets) T₁ and T₂ are selected. Then, the controller 280 change the status of the switches 122a-122d and 250a-250d at each period quarter transition point and at the peak or “zero” crossing. Because of system real components, there may be a small deviation of the “zero” value (offset) that is defined while the system is being developed.

Thus, when the energy flow (the current amplitude) is low, the current signal period (e.g., two times T₁ plus T₂) is small, but when the energy flow is high, the period may be large. In frequency terms, the signal frequency for controlling the switches 122a-122d and 250a-250d may be high for low current amplitudes and may be low for high current amplitudes.

However, because the component properties (i.e., switch properties) change with frequency, there may be a need to operate in a finite range of frequencies. In this sense, then, a maximum frequency of 100 kHz is considered, and then, a range from 50 kHz to 100 kHz is considered to provide the power variations for the DC/DC converter 300. As explained, other power ranges may be achieved by scalation. If less current is requested (or during system start-up), as the frequency cannot be increased, the system may employ a burst strategy, where the controller periodically disables either the PWM (for example providing frequency=0) or the MOSFET drivers (e.g., a switch driver) (e.g., through an EN input).

An overall time for activating the switches 122a-122d and 250a-250d (e.g., T_{sw}) may be determined based on the following:

T_{sw}=max(2*(T₁+T₂), 1/100kHz), or

T_{sw}=min(2*(T₁+T₂), 1/50kHz)

A duty cycle for controlling the switches 122a-122d on the primary side 142 may be based on the following:

D₁=T₂/T_{sw}

A duty cycle for controlling switches 250a-250d on the secondary side 144 may be based on the following:

D2=(T₁+T₂)/T_{sw}=0.5

FIG. 10 generally depicts resulting signals while controlling one or more of the switches 122a-122d and 250a-250d of the DC/DC converter 300 of FIG. 5 when the DC/DC converter is in a boost mode in accordance with one embodiment. In terms of a control strategy for the DC/DC converters 200 and 300, such converters 200 and 300 are configured to provide energy transfer, voltages at the input (V_{HV}), the output (V_{LV}), the transformer primary side (vₚ) and secondary side (vₛ) may be measured by voltage sensor(s). As noted above, the vehicle system generally provides the target (OBJ) for input and output voltages, as well as output current. As the design parameters (e.g., the transformer leakage inductance (L_{LK}) and the transformer ratio (nₜ)) may also be required. To operate the DC/DC converters, the different switches (each of the bridge MOSFETs) 122a-122d, 250a-250d, and/or 260a-260d may be digitally switched to enable a linear current increase or decrease in, for example, four possible phases, or signal period quarters (see T₁ and T₂ in FIG. 10). The rate of increase or decrease at each phase (e.g., the current signal slopes) may be dependent of the system parameters and, thus, constant at each signal period.

At the first period quarter of the current (is) in the secondary side 144 of the transformer 140:

$$I ( t ) = - \frac{{V}_{LV}}{{L}_{lk}} \cdot t + {I}_{0}$$

where Lₗₖ is a transformer leakage inductance (e.g., a design parameter). And then:

$$@ t = {T}_{1} , I ( {T}_{1} ) = {I}_{1} then$$

$${I}_{1} = - \frac{{V}_{LV}}{{L}_{lk}} \cdot {T}_{1} + {I}_{0}$$

At the second period quarter:

$$I ( t ) = - \frac{{V}_{LV} - {V}_{HV} / n}{{L}_{lk}} \cdot t + {I}_{1}$$

$$@ t = {T}_{2} , I ( {T}_{2} ) = {I}_{0} then$$

and then, at the “zero” crossing:

$${I}_{0} = - \frac{{V}_{LV} - {V}_{HV} / n}{{L}_{lk}} \cdot {T}_{2} + {I}_{1}$$

Operating these two equations leads to

$${T}_{2} = \frac{{V}_{LV}}{{V}_{LV} - {V}_{HV} / n} \cdot {T}_{1} = α \cdot {T}_{1}$$

Where n is a design parameter (e.g., number of turns of the transformer 140). Compensation factor α may be determined as follows:

α=V_{LV}/(V_{LV}−V_{HV}/n)

As noted above, to vary the energy transfer by the DC/DC converter 300 (e.g., via the current amplitude), only the duration of the quarters may be adjusted (T₁ and T₂). Thus, according to the energy transfer needs (the voltage and current targets), T₁ and T₂ are selected. Then, the controller 280 change the status of the switches 122a-122d and 250a-250d at each period quarter transition point and at the peak or “zero” crossing. Because of system real components, there may be a small deviation of the “zero” value (offset) that is defined while the system is being developed.

Thus, when the energy flow (the current amplitude) is low, the current signal period (e.g., two times T₁ plus T₂) is small, but when the energy flow is high, the period may be large. In frequency terms, the signal frequency for controlling the switches 122a-122d and 250a-250d may be high for low current amplitudes and may be low for high current amplitudes.

However, because the component properties (i.e., switch properties) change with frequency, there may be a need to operate in a finite range of frequencies. In this sense, then, a maximum frequency of 100 kHz is considered, and then, a range from 50 kHz to 100 kHz is considered to provide the power variations for the DC/DC converter 300. As explained, other power ranges may be achieved by scalation.

An overall time for activating the switches 122a-122d and 250a-250d (e.g., T_{sw}) may be determined based on the following:

T_{sw}=max(2*(T₁+T₂), 1/100kHz) or

T_{sw}=min(2*(T₁+T₂), 1/50kHz)

A duty cycle for controlling the switches 122a-122d on the primary side 142 may be based on the following:

D₁=T₁T_{sw}

A duty cycle for controlling switches 250a-250d on the secondary side 144 may be based on the following:

D₂=(T₁+T₂)/T_{sw}=0.5

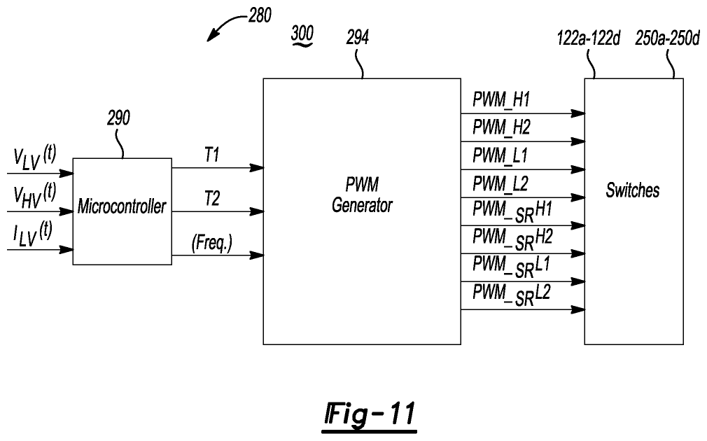

FIG. 11 generally depicts aspects related to the controller 280 that are associated with the DC/DC converter 300 in accordance with one embodiment. The controller 280 includes a microcontroller 290 and a pulse width modulation (PWM) generator 294. It is recognized that the functions performed by the microcontroller 290 and the PWM generator 294 may be distributed on any number of controllers 280. A single controller 280 is illustrated for purposes of description. The DC/DC converter 300 may operate at a frequency of 100 KHz. However, the microcontroller 450 may be arranged to operate a first frequency of, for example, 10 KHz. This aspect may provide for a more cost-efficient implementation. In particular, the microcontroller 290 is generally configured to operate at the first frequency that is less than a second frequency (e.g., 100 KHz) at which the control circuit 294 selectively activates/deactivates the switches 122a-122d and 250a-250d.

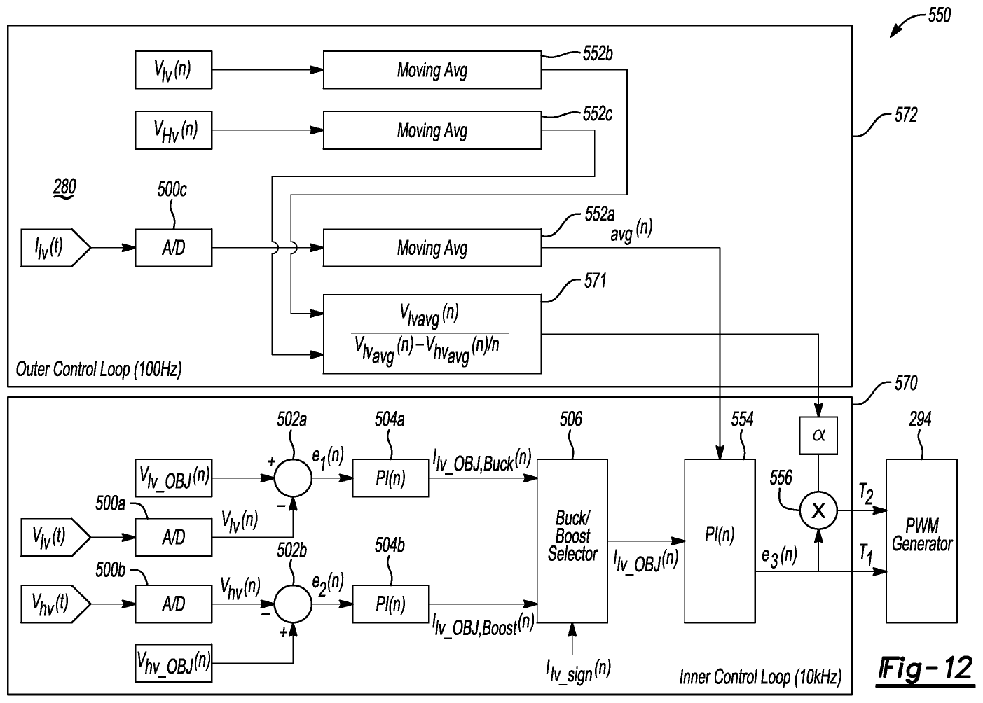

The microcontroller 290 receives inputs corresponding to V_{LV}(t) (e.g., measured voltage output on the LV network (or LV side 132)) (or low voltage signal), V_{HV}(t) (e.g., measured voltage output on the HV network (or HV side 124) (or high voltage signal), and I_{LV}(t) (e.g., measured current across an output of the LV network 132) (or current signal). The signals are received in the time domain where they are converted into the digital domain by the microcontroller 290. The microcontroller 290 generates a first activation signal T₁ and a second activation signal T₂ based at least on V_{LV}(t), V_{HV}(t), and I_{LV}(t). This aspect will be described in more detail in connection with FIG. 12. The microcontroller 290 operates the PWM generator 294 at, for example, 50 kHz to 100 KHz. It is recognized that the microcontroller 290 may operate at, for example, 100 Hz or 10 KHz. The PWM generator 294 receives the first and second activation signals T₁ and T₂ to generate various control signals that control the switching operation of the switches 122a-122d and 250a-250d (e.g., signals PWM_H1, PWM_H2, PWM_L1, PWM_L2 for switches 122a-122d, respectively, and signals PWM_srH1, PWM_srH2, PWM_srL1, PWM_srH1 for switches 250a-250d, respectively). The control circuit 24 generates the signals PWM_H1, PWM_H2, PWM_L1, PWM_L2 and the signals PWM_srH1, PWM_srH2, PWM_srL1, and PWM_srL2 somewhere in the range of 100 KH for the various switches 122a-122d and 250a-250d.

FIG. 12 generally depicts a more detailed implementation 550 of the microcontroller 290 within the controller 280 as set forth in FIG. 11 in accordance with one embodiment. The microcontroller 290 generally includes a first control loop 570 (or inner control loop) and a second control loop 572 (or outer control loop). The first control loop 570 may operate at, for example, an operating frequency of 10 KHz and the second control loop 572 may operate at, for example, an operating frequency of 100 Hz.

The first control loop 570 includes analog-to-digital converters (ADCs) 500a-500b, adders 502a-502b, a plurality of proportional integral (PI) controllers 504a-504b, a multiplexer circuit 506, and a first PI controller 554, a multiplier circuit 556, and the (PWM) generator 294. The second control loop 572 includes an ADC 500c, a plurality of moving average blocks 552a-552c, and a compensation block 571. In general, the first control loop 570 may operate at a frequency of, for example, 10 kHz and the second control loop 572 may operate at a frequency of, for example, 100 Hz. For purposes of introduction and which will be referenced herein, V_{HV,OBJ}(n) corresponds to desired voltage on the HV side 124 (or a predetermined voltage on the HV side 124 (or HV network), V_{LV,OBJ}(n)) corresponds to a predetermined threshold voltage on the LV side 132 (or LV network), and I_{LV,OBJ}(n) (or a predetermined current threshold) corresponds to the desired current on the LV-network 132.

In connection with the first control loop 570, the ADC 500a receives the low voltage signal (V_{LV}(t)) and converts the same into a digital low voltage signal (e.g., V_{LV}(n)). The adder 502a takes a difference between the digital low voltage signal and the low voltage threshold signal (V_{LV,OBJ}(n)) to generate a first error signal (e.g., e₁(n)). The PI controller 504a integrates the first error signal to generate a first desired input current value (e.g., I_{LV,OBJ_BUCK}(n)) which is provided to the multiplexer circuit 506. If the DC/DC converter 300 is in the buck mode, (e.g., decreasing voltage from the HV side 124 (or primary side 142) to the LV side 132 (or secondary side 144)), then the multiplexer circuit 506 transmits the signal I_{LV,OBJ_BUCK}(n) to the first PI controller 554.

Similarly, the ADC 500b receives the high voltage signal (V_{HV}(t)) and converts the same into a digital high voltage signal (e.g., V_{HV}(n)). The adder 502b takes a difference between the digital high voltage signal and the high voltage threshold signal (V_{HV,OBJ}(n)) to generate a second error signal (e.g., e₂(n)). The PI controller 504b integrates the second error signal to generate a second desired input current value (e.g., I_{LV,OBJ_BOOST}(n)) which is provided to the multiplexer circuit 506. If the DC/DC converter 300 is in the boost mode, (e.g., increasing voltage from the LV side 132 (e.g., secondary side 144) to the HV side 124 (e.g., primary side 142)), then the multiplexer circuit 506 transmits the signal I_{LV,OBJ_BOOST}(n) to the first PI controller 554.

In one example, the multiplexer circuit 506 monitors whether a signal I_{Iv_sign}(n) has a positive polarity or a negative polarity. In general, the signal I_{Iv_sign}(n) may be used as a control signal and generally corresponds to whether the DC/DC converter 300 operates in a buck or boost mode based on the polarity (e.g., current flows from HV side 124 to LV side 132 (e.g., buck mode) or current flows from LV side 132 to HV side 124 (e.g., boost mode)). The signal I_{LV_SIGN}(n) may be a system signal to control the operational mode of the DC/DC converter 300. In another example, the signal I_{Iv_sign}(n) may correspond to a signal that is transmitted on a vehicle data communication bus to the microcontroller 290 (e.g., to the controller 280) that is indicative of a command for the DC/DC converter 300 to enter into a buck mode or a boost mode. The signal I_{v_sign}(n) may also correspond to a direct measurement of current/voltage that indicates whether the DC/DC converter 300 is in the buck mode or boost mode to provide an automatic transition between such modes. The multiplexer circuit 506 selects either the first desired input current value or the second desired input current value to provide a final desired input current value (e.g., I_{LV,OBJ}(n)) based on the type of mode the DC/DC converter 300 is in (e.g., buck or boost mode).

The second control loop 572 operates in the following manner. The ADC 500c receives the low current signal (I_{LV}(t)) and converts the same into a digital low current signal (e.g., I_{LV}(n)). The moving average block 552a receives the digital low current signal I_{LV}(n) and takes an average of a predetermined number of readings for the low current signal and outputs an average signal avg(n). The moving average block 552b receives the digital low voltage signal (e.g., V_{LV}(n)) and the moving average block 552c receives the digital high voltage signal (e.g., V_{HV}(n)). The moving average blocks 552b, 552c takes an average of a predetermined number of readings for the digital low voltage signal (e.g., V_{LV}(n)) and the digital high voltage signal (e.g., V_{HV}(n)) and outputs the same to the compensation block 571. The compensation block 571 calculates the compensation factor α based on the average of the predetermined number readings for the digital low voltage signal (e.g., V_{LV}(n)) and the digital high voltage signal (e.g., V_{LV}(n)) based on the equation noted above and further based on the equation as illustrated in FIG. 12.

The moving average block 552a outputs the average signal, avg(n) to the first PI controller 554. The first PI controller 554 obtains an error signal (e3(n)) between the average signal as provided by the moving average block 552 of the second control loop 572 and the signal I_{LV,OBJ}(n). The signal e₃(n) corresponds to the first activation signal T₁. The multiplier circuit 556 multiplies the compensation factor α to the error signal to provide second activation signal, T₂ (e.g., this is represented by α*T₁ as noted in connection with FIGS. 9 and 10). The activation signals T₁ and T₂ are then provided to the PWM generator 294 which generates PWM based control signals to drive the switches 122a-122b and 250a-250d in both the buck and boost modes.

In general, the microcontroller 290 as set forth in FIG. 12 including the first control loop 570 and the second control loop 572 utilize the compensation factor α along with T₁ as a basis for determining T₂. This aspect mitigates the need to utilize a current sensor the current at the secondary (iₛ) (i.e., iₘₑₐₛ). It bears mentioning that the current at the LV side ((I_{LV}) may still be measured but at a low speed and with averaging. As such, it is possible to obtain higher robustness for the converter 300 since the noise that is present in current sensing is thereby eliminated thereby leading to improved control provided by the microcontroller 290. Additionally, by eliminating the current sensor(s), the converter 300 may provide a cost advantage over prior converter implementations.

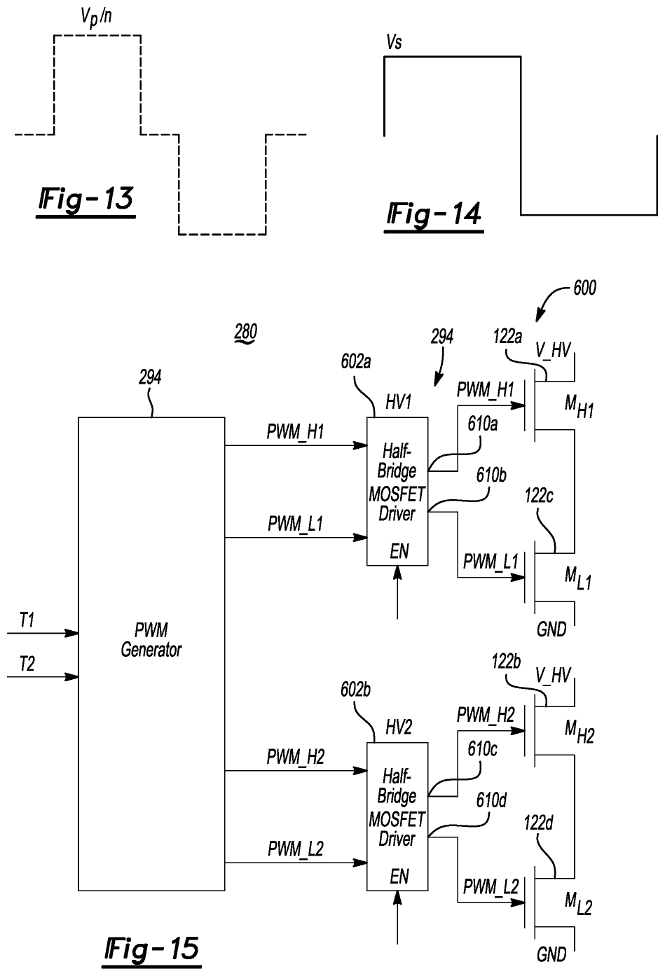

FIG. 13 depicts a voltage input (e.g., vₚ/n) at the primary winding 142 of the DC/DC converter 300 (e.g., and as converted by the secondary side) in accordance with one embodiment. FIG. 14 depicts a voltage output at the secondary winding 144 of the DC/DC converter 300 in accordance with one embodiment.

FIG. 15 depicts a schematic view of the controller 280 of FIG. 11 in accordance with one embodiment. The controller 280 includes the PWM generator 294 and a plurality of switch drivers 602a-602b that are operably coupled to the switches 122a-122d on the primary side 142. It is recognized that the number of switch drivers 602a-602b employed in the controller 280 may vary based on the desired criteria of a particular implementation. The PWM generator 294 generates control signals to control the switch drivers 602a-602b in response to the activation signals T₁ and T₂. The switch drivers 602a-602b controls the switching of the switches 122a-122d on the primary side 142 while the DC/DC converter 300 is in a buck mode (e.g., energy transfer (or conversion) from high voltage to low voltage). The switch drivers 602a-602b include a first output 610a and 610c, respectively, to each transmit a signal PWM_H1 and PWM_H2, respectively, to transition the switches 122a and 122c into a high state. The switch drivers 602a-602b include a second output 610b and 610d, respectively, to transmit a signal PWM_L1 and PWM_L2, respectively, to transition the switches 122b and 122d into a low state

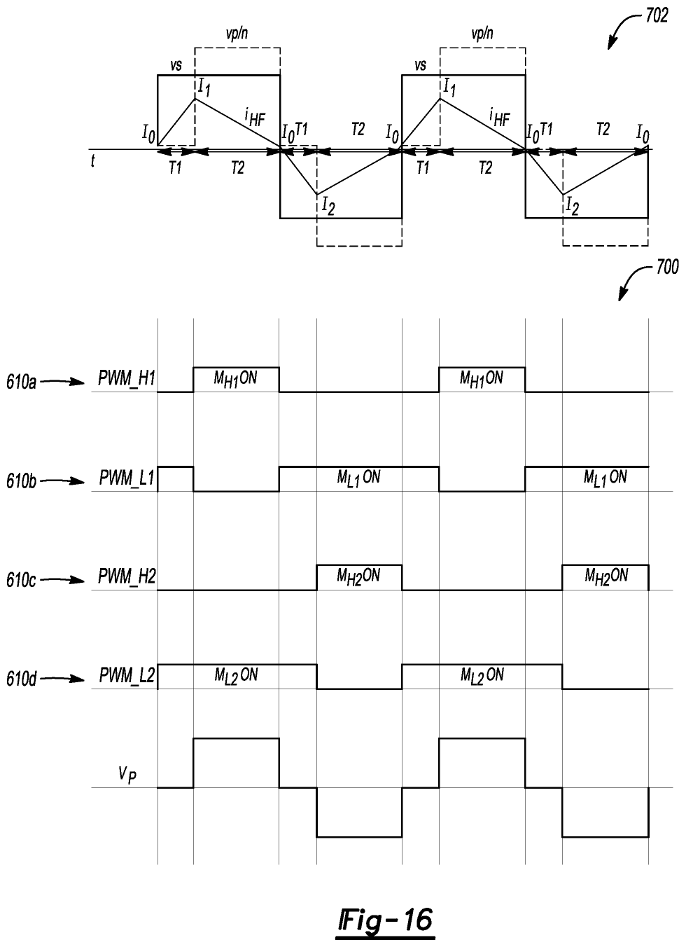

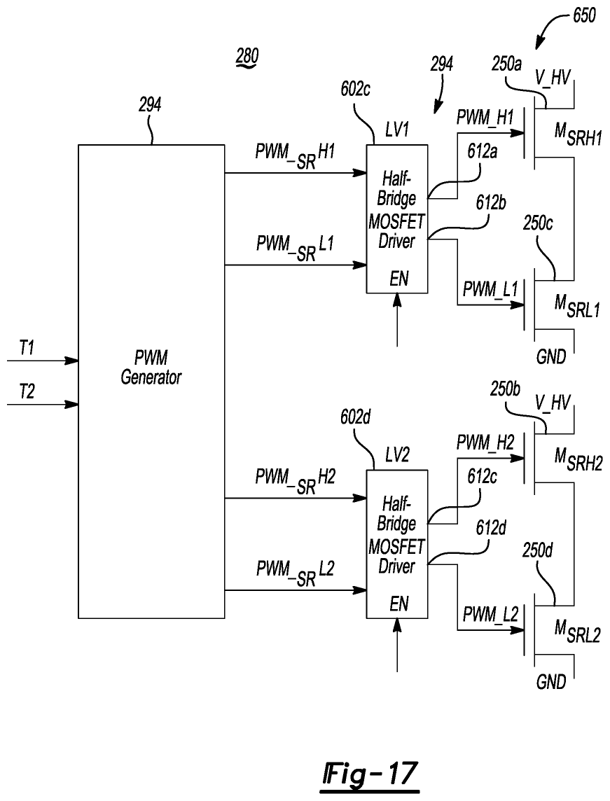

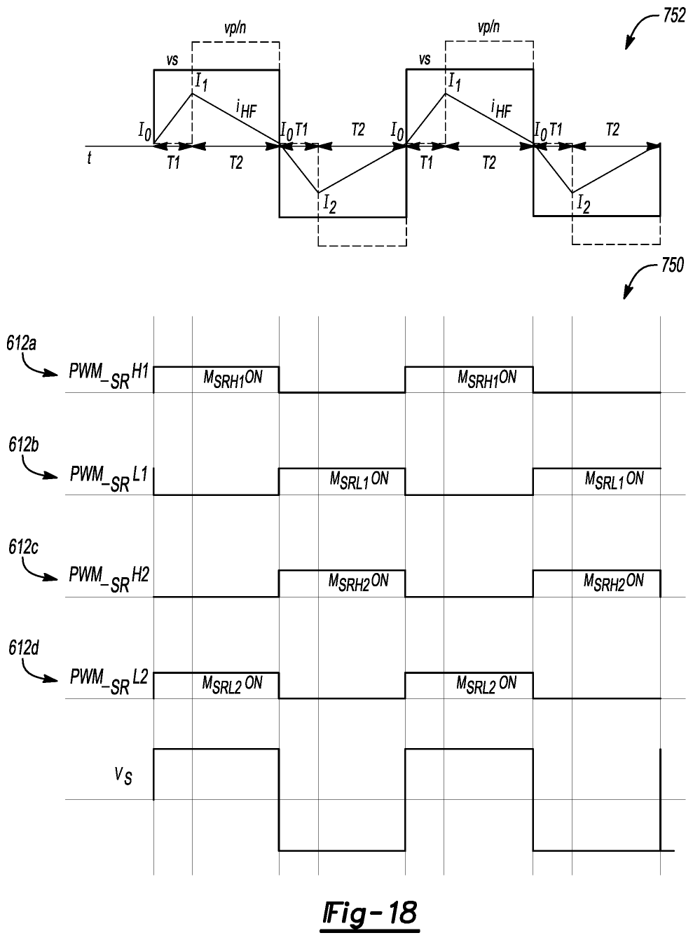

FIG. 16 generally illustrates the states of the outputs 610a-610d of FIG. 15 based on the activation signals T₁ and T₂ while the DC/DC converter 300 is in the buck mode (e.g., energy transfer (or conversion) from high voltage to low voltage). The states of the outputs 610a-610d are generally shown at 700. The states of the outputs 610a-610d are generally shown in reference to voltage at the primary winding 142 (v_{p/n}) and the voltage at the secondary winding 144 (vₛ) over time (this is generally shown at 702). When the switches 122a and 122d are activated or ON, the primary winding 142 receives a high voltage and when the switches 122b and 122c are ON, the primary winding 142 receives the high voltage at an inverted state.

FIG. 17 depicts a schematic view of the controller 280 of FIG. 11 in accordance with one embodiment. The controller 280 includes the PWM generator 294 and a plurality of switch drivers 602c-602d that are operably coupled to the switches 250a-250d on the secondary side 144. It is recognized that the number of switch drivers 602c-602d employed in the controller 280 may vary based on the desired criteria of a particular implementation. The PWM generator 294 generates control signals to control the switch drivers 602c-602d in response to the activation signals T₁ and T₂. The switch drivers 602c-602d control the switching of the switches 250a-250d on the secondary side 144 while the DC/DC converter 300 is in a buck mode (e.g., energy transfer (or conversion) from high voltage to low voltage). The switch drivers 602c-602d include a first output 612a and 612c, respectively, to each transmit a signal PWM_H1 and PWM_H2, respectively, to transition the switches 250a and 250b into a high state. The switch drivers 602c-602d include a second output 612b and 612d, respectively, to transmit a signal PWM_L1 and PWM_L2, respectively, to transition the switches 250c and 250d into a low state.

FIG. 18 generally illustrates the states of the outputs 612a-612d of FIG. 17 based on the activation signals T₁ and T₂ while the DC/DC converter 300 is in the buck mode (e.g., energy transfer (or conversion) from high voltage to low voltage). The states of the outputs 612a-612d are generally shown at 750. The states of the outputs 612a-612d are generally shown in reference to voltage at the primary winding 142 (v_{p/n}) and the voltage at the secondary winding 144 (vₛ) over time (this is generally shown at 752). When the switches 250a and 250d are activated or ON, the secondary side 144 of the transformer 140 (e.g., vₛ), for example, receives the low voltage of the LV side 132. Also, when the switches 250b and 250c are activated or ON, the secondary side 144 of the transformer 140 (vₛ) receives an inverted low voltage of the LV side 132. Thus, when the switches 250a and 250d are activated or ON, the secondary side 144 of the transformer 140 receives the low voltage in an inverted state.

To this point in the disclosure, the examples as set forth describe the transfer of energy from the HV side 124 to the LV side 132 (e.g., the DC/DC converter 300 is in a buck mode in this state). This may generally be the case for voltage conversions ranging from 400V to 12V, 800V to 12V, 400V to 48V, 800V to 48V or even 48V to 12V. However, in the vehicle 126, there may be moments in which a reverse energy transfer may be needed or requested (i.e., the DC/DC converter 300 operates in a boost mode).

In general, the transition from the buck to boost mode may be decided based on system requirements. In the boost mode, the multiplexer circuit 506 as set forth in FIG. 12 may be switched to the boost mode to select the voltage processing of the HV side 124 to generate the target current I_{LV_OBJ}(n).

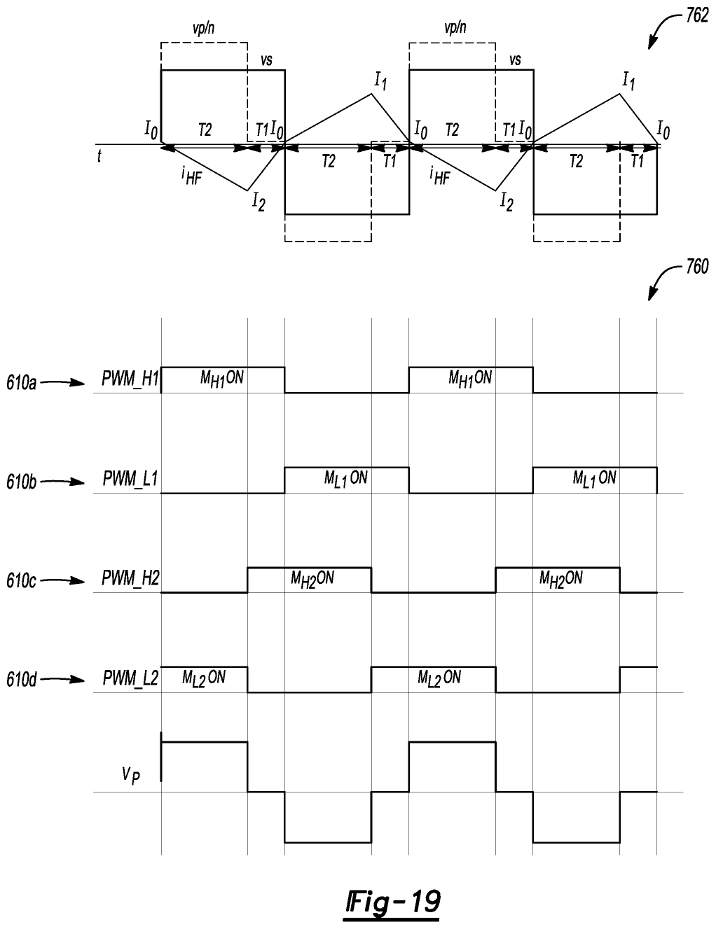

FIG. 19 generally illustrates the states of the outputs 610a-610d of FIG. 15 based on the activation signals T₁ and T₂ while the DC/DC converter 300 is in the boost mode (e.g., energy transfer (or conversion) from the low voltage side 132 to the high voltage side 124) for the switches 122a-122d on the primary side 142. The states of the outputs 610a-610d are generally shown at 760. The states of the outputs 610a-610d are generally shown in reference to voltage at the primary winding 142 (v_{p/n}) and the voltage at the secondary winding 144 (vₛ) over time (this is generally shown at 762). The operation of the switches 122a and 122d and the switches 122b and 122c as noted in connection with FIG. 16 apply here however, the converter 300 operates in the boost mode, (e.g., increasing voltage from the LV side 132 (e.g., secondary side 144) to the HV side 124 (e.g., primary side 142)).

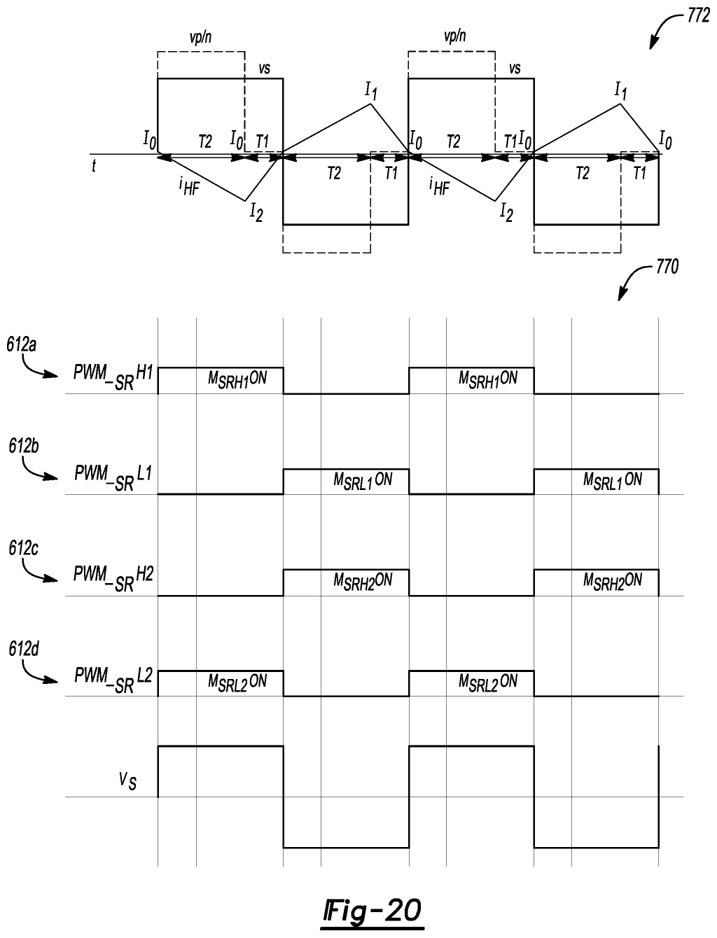

FIG. 20 generally illustrates the states of the outputs 612a-612d of FIG. 15 based on the activation signals T₁ and T₂ while the DC/DC converter 300 is in the boost mode (e.g., energy transfer (or conversion) from the low voltage side 132 to the high voltage side 124) for the switches 250a-250d on the secondary side 144. The states of the outputs 610a-610d are generally shown at 770. The states of the outputs 610a-610d are generally shown in reference to voltage at the primary winding 142 (v_{p/n}) and the voltage at the secondary winding 144 (vₛ) over time (this is generally shown at 772). The operation of the switches 250a and 250d and the switches 250b and 250c as noted in connection with FIG. 18 apply here however, the converter 300 operates in the boost mode, (e.g., increasing voltage from the LV side 132 (e.g., secondary side 144) to the HV side 124 (e.g., primary side 142)).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A power conversion device for a vehicle, the power conversion device comprising:
a transformer including a primary side and a secondary side; and
at least one controller configured to:
selectively switch a first plurality of switches on the primary side and a second plurality of switches on the secondary side to convert a first input signal into a first output signal;
receive a high voltage signal on the primary side in response to converting the first input signal into the first output signal;
receive a low voltage signal on the secondary side in response to converting the first input signal into the first output signal;
generate a compensation factor α based at least on the high voltage signal, and the low voltage signal; and
provide a first activation signal to control the switching of the first plurality of switches and the second plurality of switches based at least on the compensation factor.

2. The power conversion device of claim 1, wherein the at least one controller is further configured to generate a second activation signal to control the switching of the first plurality of switches and the second plurality of switches based at least on the high voltage signal and the low voltage signal.

3. The power conversion device of claim 2, wherein the at least one controller is configured to multiply the second activation signal to the compensation factor to generate the first activation signal.

4. The power conversion device of claim 2, wherein the at least one controller includes a first control loop programmed to generate the compensation factor at a first operating frequency.

5. The power conversion device of claim 4, wherein the at least one controller includes a second control loop programmed to generate the first activation signal and the second activation signal at a second operating frequency.

6. The power conversion device of claim 5, wherein the second operating frequency is greater than the first operating frequency.

7. The power conversion device of claim 2, wherein the second activation signal is based on the high voltage signal on the primary side and the low voltage signal on the secondary side.

8. The power conversion device of claim 1, wherein the compensation factor is further based on a number of turns of the transformer.

9. The power conversion device of claim 8, wherein the at least one controller includes at least one moving average block programmed to a provide an average number of readings of the high voltage signal and the low voltage signal prior to generating the compensation factor.

10. A method for operating a power conversion device for a vehicle, the method comprising:
selectively switching a first plurality of switches on a primary side of a transformer and a second plurality of switches on a secondary side of the transformer to convert a first input signal into a first output signal;
receiving a high voltage signal on the primary side in response to converting the first input signal into the first output signal;
receiving a low voltage signal on the secondary side in response to converting the first input signal into the first output signal;
generating a compensation factor α based at least on the high voltage signal and the low voltage signal; and
providing a first activation signal to control the switching of the first plurality of switches and the second plurality of switches based at least on the compensation factor.

11. The method of claim 10 further comprising generating a second activation signal to control the switching of the first plurality of switches and the second plurality of switches based at least on the high voltage signal and the low voltage signal.

12. The method of claim 11 further comprising multiplying the second activation signal to the compensation factor to generate the first activation signal.

13. The method of claim 11 further comprising operating a first control loop to generate the compensation factor at a first operating frequency.

14. The method of claim 13 further comprising operating a second control loop generate the first activation signal and the second activation signal at a second operating frequency.

15. The method of claim 14, wherein the second operating frequency is greater than the first operating frequency.

16. The method of claim 11, wherein the second activation signal is based on the high voltage signal on the primary side and the low voltage signal on the secondary side.

17. The method of claim 10, wherein the compensation factor is further based on a number of turns of the transformer.

18. The method of claim 17 further comprising providing an average number of readings of the high voltage signal and the low voltage signal prior to generating the compensation factor.

19. A computer-program product embodied in a non-transitory computer readable medium that is programmed to operate a power conversion device for a vehicle, the computer-program product comprising instructions to:
selectively switch a first plurality of switches on a primary side of a transformer and a second plurality of switches on a secondary side of the transformer to convert a first input signal into a first output signal;
receive a high voltage signal on the primary side in response to converting the first input signal into the first output signal;
receive a low voltage signal on the secondary side in response to converting the first input signal into the first output signal;
generate a compensation factor α based at least on the high voltage signal and the low voltage signal; and
provide a first activation signal to control the switching of the first plurality of switches and the second plurality of switches based at least on the compensation factor.

20. The computer-program product of claim 19 further comprising instructions to generate a second activation signal to control the switching of the first plurality of switches and the second plurality of switches based at least on the high voltage signal and the low voltage signal.
